(19) United States
(12) Patent Application Publication
(10) Pub. No.: US 2004/0186709 A1
(43) Pub. Date: Sep. 23, 2004

(54) System and method of synthesizing a plurality of voices

(76) Inventor: Chao-Wen Chi, Hsinchu (TW)

Correspondence Address: BAKER & BOTTS, 30 ROCKEFELLER PLAZA, NEW YORK, NY, 10112

(21) Appl. No.: 10/390,356

(22) Filed: Mar. 17, 2003

(51) Int. Cl. G10L 19/14

(52) U.S. Cl. 704/211

(57) ABSTRACT

A system and method of synthesizing a plurality of voices are described. The system has a processing unit, a register, a latch unit, a timer and a digital/analog converter. The processing unit decodes voice data into decoded voices and the decoded voices are then transmitted to the register. A plurality of different sampling signals of the timer are transmitted to the latch unit to trigger periodically the latch unit and the latch unit sequentially fetches the decoded voices stored in the register to prevent effectively jitters when the voice data are synthesized.

### FIELD OF THE INVENTION

The present invention generally relates to a system and method of synthesizing a plurality of voices, and more particularly, to a system and method of synthesizing the voices by a latch unit to prevent a jitter phenomenon when the voices are synthesized on different voice channels.

### BACKGROUND OF THE INVENTION

Application of digital voice is widely used along with the rapid growing of information and communication technology. For example, the digital coding of the voice synthesis is usually applied to deal with voice transmission in electronic consumer toys or mobile phones. Particularly, the encoding/decoding technique of the voice synthesis is utilized to perform an audio transmission so that the user can clearly listen to the audio after the voices are synthesized for the purpose of entertainment and communication, respectively.

FIG. 1 shows a block diagram of a voice synthesizer according to the prior art. The voice synthesizer typically includes a processing unit 100, a register 102, a digital/analog converter 104 and a speaker 106. A clock signal is first input to the processing unit 100 and the register 102 to actuate the processing unit 100 by the clock signal for calculation of voice data and formation of decoded voices. The clock signal is also input into the register 102 and triggers the register 102. The decoded voices are then sent from the processing unit 100 to the register 102. Afterwards, the decoded voices are transmitted sequentially to the digital/analog converter 104 and the speaker 106 when the processing unit 100 finishes the decoding calculation of the decoded voices.

FIG. 2 shows an output time chart of the voice synthesizer in FIG. 1 according to the prior art. The X-axis represents time and the Y-axis represents the amplitude of the signal. SC designates a sequence of working signals of the processing unit 200. T1, T2, . . . , Tn are the sampling periods of the voice signals of the processing unit 100. D1, D2 . . . , Dn are the decoded voices obtained by using a firmware program when the voice data are decoded during a sampling period.

Theoretically, before the sampling periods T1, T2 of the working signal is over, the processing unit 100 must transmit the decoded voices D1, D2 to the register 102 so as to allow the digital/analog converter 106 to read easily the decoded voices. However, the processing unit 100 needs to perform a decoding step and simultaneously receives another interrupted request signal I1 from the peripheral devices. The processing unit 100 therefore spends a lot of additional calculation time responding to the interrupted request signal I1 resulting in an incomplete decoding of the decoded voices within a sampling period T2. That is, the incomplete decoding is delayed to the next duty cycle T3. The processing unit 100 is hence unable to transmit the decoded voice D2 to the register 102 during the sampling period T2 and only transmits the same in the sampling period T3.

Furthermore, the processing unit 100 receives a lot of interrupted request signals (In) in the voice synthesizer during the duty cycles. Since the interrupted request signals (In) severely consume the calculation time (such as MIPS of the processing unit 100), the decoded voices cannot be accomplished in sampling period so that the digital/analog converter 104 fails to read the decoded voices from the register 102. A distortion of the synthesized voice is thus formed in the so-called jitter phenomenon. In other words, there is serious signal drift and loud noise within the decoded voices, reducing the quality of the synthesized voices.

### SUMMARY OF THE INVENTION

One object of the present invention is to utilize a system and method of synthesizing voices to control a latch unit by using sampling signals from a timer so that the latch unit can acquires decoded voices stored in the register. As a result, the inadequate MIPS problem of the processing unit is solved to increase the multi-task efficiency of the processing unit.

Another object of the present invention is to utilize a system and method of synthesizing voices to allow a plurality of timers to create a plurality of asynchronous signals (voice channels). The asynchronous signals are used to trigger a plurality of latch unit so that the latch unit periodically transmits the decoded voices according to the sampling period of the asynchronous signals to avoid jitters between the decoded voices.

Still another object of the present invention is to utilize a system and method of synthesizing voices to form voice channels with various sampling periods. The voice channels can diminish the use of the memory of the decoded voices to reduce production cost of the voice synthesizer.

According to the above objects, the present invention sets forth a system and method of synthesizing voices. The system typically has a memory, a processing unit, a register, a latch unit and a digital/analog converter. The voice data is stored in the memory. The processing unit is coupled to the memory and triggered by a clock signal so that the processing unit can read the voice data stored in the memory and decode the voice data into decoded voices. The register is connected to the processing unit and actuated by the clock signal for receiving the decoded voice from the processing unit.

The latch unit is coupled to the register and controlled by a timer for acquiring the decoded voices within the register. The timer transmits a sampling signal to the latch unit for triggering periodically the latch unit according the period of the sampling signal and the latch unit sequentially reads the decoded voices from the processing unit to prevent the jitters within the synthesized voice. The digital/analog converter is coupled to the latch unit for transferring the decoded voices into analog synthesized voices to output the analog synthesized voice.

Specifically, one or more timers are incorporated into the latch unit to forms various sampling signals with different frequency, respectively. The latch unit then downloads the decoded voices stored in the register and transmits them into a speaker in place of the transmission mode of the processing unit in the prior art. A lot of MIPS of the processing unit are therefore advantageously economized. Moreover, since each of the decoded voices is periodically conveyed, the jitters in which appear the decoded voices are completely eliminated.

Since the timers are independent of the processing unit and the latch unit is embedded into the voice synthesizer, the latch unit does not affect the processing unit. The MIPS time of the processing unit is not appropriated by the latch unit so that latch unit is allowed to fetch regularly the decoded voices and to transmit periodically the decoded voices in the predetermined time. If the processing unit accomplishes the calculation of two decoded voices responsive to two sampling signals, two timers can be incorporated into the latch unit. Consequently, the decoded voices are periodically sent to the digital/analog converter on the basis of the sampling period of the two timers.

More importantly, the present invention is advantageously suitable for a plurality of different sampling periods (asynchronous signals) in a multi-channel voice synthesizer. Since the transmission of the decoded voices is controlled by the processing unit in the prior art, the conventional processing unit must finish the decoding calculation of one or more voice channels on time during one duty cycle. For simplification and stability of the voice synthesizer in the present invention, the interrupted request signals between the voice channels are not accessible within the voice synthesizer.

That is, if the transmission of the decoded voice in the voice channel is progressive, the interrupted request signal of the second voice channel to the processing unit needs to be waited for that of the first voice channel. That is, if the transmission of the decoded voice in the voice channel is progressive, the interrupted request signal of the second voice channel requested by the processing unit needs to wait for the transmission of the first voice channel. The processing unit therefore deals with the interrupted request of the second voice channel.

In the present invention, a plurality of timers is incorporated into the latch unit to serve as a trigger mechanism. The latch unit voluntarily fetches the decoded voices in the register according to the first sampling period and the second sampling period. Further, the latch unit regularly sends the decoded voices on each voice channel of the voice synthesizer to solve the problem of the transmission delay resulting in jitters. More importantly, the acquisition sequence of the decoded voices between the voice channels is on the basis of the sampling period of the timers to avoid distortion between decoded voices of the voice channels.

In summary, a system and method of synthesizing voices of the present invention utilize a timer to control a latch unit so that the latch unit can fetch decoded voices stored in the register to solve the problem of insufficient MIPS time of the processing unit and to increase the multi-task efficiency of the process of the processing unit. Further, using a plurality of timers to form a plurality of asynchronous sampling signals allows the latch unit to be triggered so that the decoded voices are delivered sequentially according to the period of the sampling signals from the timers for jitter prevention.

### BRIEF DESCRIPTION OF THE DRAWINGS

The foregoing aspects and many of the attendant advantages of this invention will become more readily appreciated as the same becomes better understood by reference to the following detailed description when taken in conjunction with the accompanying drawings, wherein:

FIG. 1 illustrates a block diagram of a voice synthesizer according to the prior art;

FIG. 2 illustrates an output time chart of the voice synthesizer in FIG. 1 according to the prior art;

FIG. 3 illustrates a block diagram of a voice synthesizer in accordance with one preferred embodiment of the present invention;

FIG. 4 illustrates an output time chart of the voice synthesizer having a timer in FIG. 3 in accordance with one preferred embodiment of the present invention;

FIG. 5 illustrates an output time chart of the voice synthesizer having a plurality of timers in FIG. 3 in accordance with one preferred embodiment of the present invention; and

FIG. 6 is a flowchart of voice synthesizer operation in accordance with one preferred embodiment of the present invention.

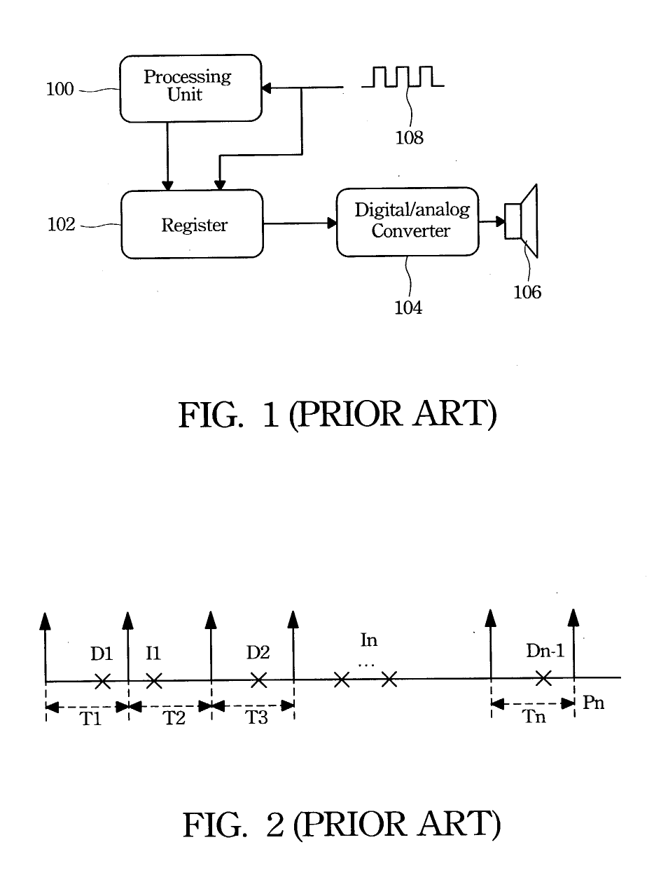

### DETAILED DESCRIPTION OF THE PREFERRED EMBODIMENT

The present invention is directed to a system and method of synthesizing a plurality of voices to improve the shortcomings of a conventional synthesizer in the prior art. A timer is used to control a latch unit to acquire actively the decoded voices stored in a register to solve the insufficient MIPS problem of the synthesizer. Further, a plurality of asynchronous sampling signals from a plurality of timers, respectively, triggers the latch unit. The latch unit then transmits sequentially the decoded voices from various channels of the timers according to the period of the asynchronous sampling signals. As a result, the jitters within the synthesized voices of the various channels are effectively eliminated.

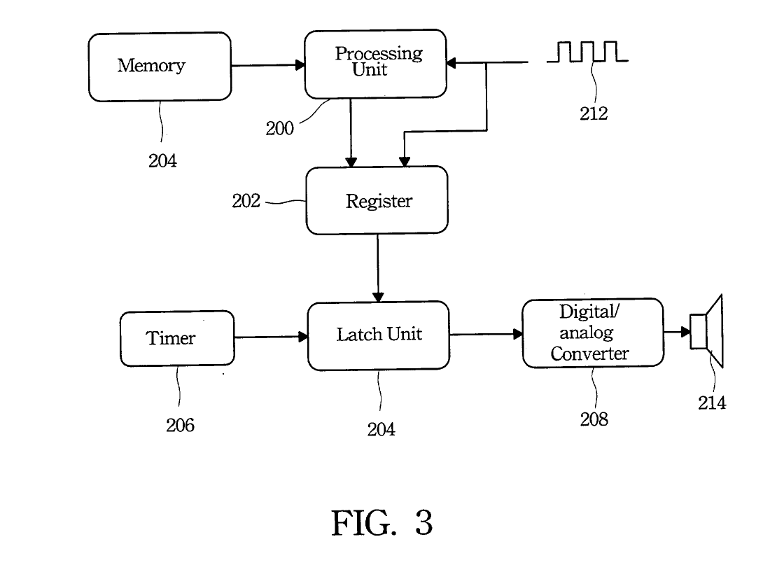

FIG. 3 shows a block diagram of a voice synthesizer in accordance with one preferred embodiment of the present invention. A plurality of voices is synthesized by calculating voice data to generate synthesized voices to prevent jitters within the synthesized voice. The voice synthesizer typically has a memory 210, a processing unit 202, a register 204, a latch unit 204 and a digital/analog converter 208. The voice data are stored in the memory 210. The processing unit 200 is coupled to the memory 210 and triggered by a clock signal 212 so that the processing unit 200 can read the voice data stored in the memory 210 and decode the voice data into decoded voices. The register 202 is connected to the processing unit 200 and actuated by the clock signal 212 for receiving the decoded voice from the processing unit 200. The latch unit 204 is coupled to the register 202 and controlled by a timer 206 for acquiring the decoded voices within the register 202. The timer 206 transmits a sampling signal to the latch unit 204 for triggering periodically the latch unit 204 according to the period of the sampling signal and the latch unit 204 sequentially reads the decoded voices from the processing unit 200 to prevent the jitters within the synthesized voice. The digital/analog converter 208 is coupled to the latch unit 204 for transferring the decoded voice into an analog synthesized voice to output the analog synthesized voice.

In the preferred embodiment of the present invention, the latch unit 204 has a plurality of layers of depth to serve as storage in a multi-layer format for the decoded voices. A first-in-first-out (FIFO) rule is applied in the layers of the depth so that the latch unit 204 stably transmits the decoded voices to the digital/analog converter 208. The processing unit 200 is, for example, a series of 6502 micro-controllers, a single chip or a general purpose of central processing unit (CPU).

In addition, the processing unit 200 can perform a waveform coding on the voice data in the time domain. The waveform coding includes a code excited linear prediction (CELP), an adaptive differential pulse code modulation (ADPCM) and a differential pulse code modulation (DPCM). The ADPCM utilizes a digital sampling of a coding technique to convert the analog signals into digital signals of voice signals. Also, ADPCM introduces the difference between the both samples of the voice data. The occupied memory of the ADPCM manner is smaller than that of the conventional PCM manner to save a lot of the memory space in the present invention.

Specifically, one or more timers 206 are incorporated into the latch unit 204 to form various sampling signals with different frequency, respectively. The latch unit 204 therefore downloads the decoded voices stored in the register 202 and transmits them into a speaker 214 in place of the transmission mode of the processing unit in the prior art. Thus, a lot of MIPS time of the processing unit 200 is advantageously economized in the present invention. Since each of the decoded voices is periodically conveyed, the jitters which appear within the decoded voices are completely eliminated. A time chart of one or a plurality of timers incorporated into the latch unit is described in detail. A voice channel is also defined as a timer including a specific frequency. In other words, a plurality of voice channels are connected to the timers 206, the latch units 204, the registers 202 (or Random Access Memory, RAM) and a plurality of firmwares, respectively.

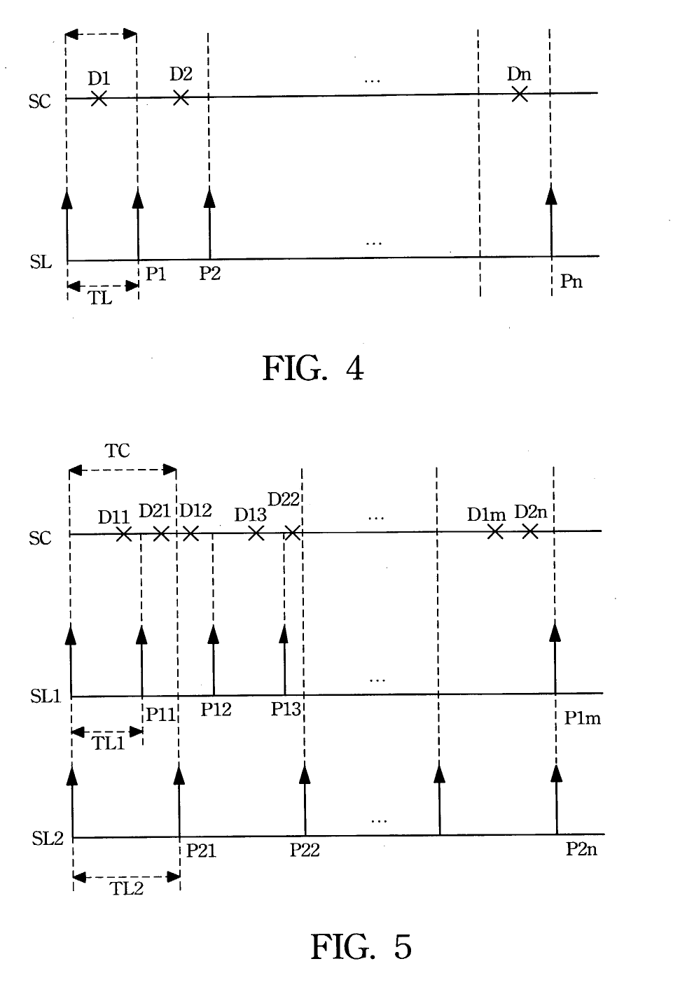

FIG. 4 shows an output time chart of the voice synthesizer having a timer in FIG. 3 in accordance with one preferred embodiment of the present invention. The X-axis represents time and the Y-axis represents the amplitude of the signal. SC designates a sequence of working signals of the processing unit 200. TC is the sampling period of a working signal. D1 is the one of the decoded voices when the voice data are calculated during a duty cycle of the working signal. SL is the sampling signal of the timer 206. TL is the sampling period of the sampling signal SL. In operation, the timer 206 triggers the latch unit 204 by using the sampling signals. The latch unit 204 then acquires the decoded voices D1 stored in the register 202 and sends the decoded voices D1 to the digital/analog converter 208 in the predetermined time to form synthesized voices. The synthesized voices continuously are transferred into the speaker 214. The rest may be deduced by analogy and the decoded voices D2, . . . , Dn are sequentially received when the latch unit 204 is triggered by the timer 206; hence the decoded voices D2, . . . , Dn are successively transferred in the predetermined time P2, . . . , Pn.

Since the latch unit 204 receives the decoded voices in the register 202 by an actuation of the sampling signals from the timer 206, the MIPS time of the processing unit 200 is not appropriated when the timer 206 is independent of the processing unit 200. As a result, the latch unit 204 effectively reduces the loading of the processing unit 200 and regularly fetches the decoded voices in the register 202. Significantly, the processing unit 200 accomplishes the calculation of a decoded voice responsive to a sampling signal before the sampling signal of the latch unit 204, and the latch unit 204 then sequentially obtains the decoded voices. Consequently, the decoded voices are periodically sent to the digital/analog converter 208 to solve the jitter problem in one channel of the synthesizer.

FIG. 5 shows an output time chart of the voice synthesizer having a plurality of timers in FIG. 3 in accordance with one preferred embodiment of the present invention. FIG. 5 is basically similar to FIG. 3. The main difference between FIG. 5 and FIG. 3 is that a plurality of timers is applied to the FIG. 5 for controlling the latch unit 204. Two timers taken for convenience in the present invention are defined as a first timer T1 and a second timer T2. The X-axis represents time and the Y-axis represents the amplitude of the signal. SC designates a sequence of working signals of the processing unit 200. TC is the duty cycle of a working signal. D11, D21 are some of the decoded voices when the voice data are calculated during a duty cycle of the working signal. SL1 is the sampling signal of the first timer; TL1 is the sampling period of the sampling signal SL1. SL2 is the sampling signal of the first timer; TL2 is the sampling period of the sampling signal SL2. In operation, the first timer T1 and the second timer T2 create a first sampling period TL1 and a second sampling period TL2, respectively. The decoded voices D11, D21 in the register 202 are acquired by the latch unit 204 when the first sampling period TL1 and the second sampling period TL2 trigger the latch unit 204 in the predetermined time P11, P21. The latch unit 204 utilizes the trigger mechanism of the first timer T1 and the second timer T2 to receive successively the decoded voices (D11,D21), (D12,D13,D22), . . . , (D1m,D2n). The decoded voices (D11,D21),(D12,D13,D22), . . . ,(D1m,D2n) are then transmitted in the predetermined time (P11,P21),(P12,P13,P22), . . . , (P1m,P2n).

Similarly, since the latch unit 204 receives the decoded voices in the register 202 by an actuation of the sampling signals from the first and the second timer 206, the MIPS time of the processing unit 200 is not advantageously appropriated when the timer 206 is independent of the processing unit 200. In other words, the latch unit 204 is embedded in the synthesizer in the hardware formation. As a result, the latch unit 204 effectively reduces the loading of the processing unit 200 so that the latch unit 204 periodically acquires the calculated decoded voice and transmits the decoded voices in the predetermined time P11, P21. Significantly, the decoded voices are acquired and transmitted to prevent the distortion of the synthesized voices during the duty cycle (TC) of the processing unit 200 according to the first sampling period T1 and the second sampling period T2.

Specifically, the processing unit 200 accomplishes the calculation of two decoded voices responsive to two sampling signals before the sampling signals of the latch unit 204, and the latch unit 204 is incorporated within two timers 206. Consequently, the decoded voices are periodically sent to the digital/analog converter 208 on the basis of the sampling period of the timers 206.

The present invention is suitable for a plurality of different sampling periods (asynchronous signals) for a multi-channel voice synthesizer. Since the transmission of the decoded voices is controlled by the processing unit in the prior art, the processing unit must accomplish voice calculation of one or more voice channels on time during one duty cycle. For simplification and stability of the voice synthesizer, the interrupted request signals between the voice channels are not accessible within the voice synthesizer. That is, if the transmission of the decoded voices in the voice channels is progressive, the interrupted request signal of the second voice channel requested by the processing unit 200 must wait for the transmission of the first voice channel. The processing unit 200 therefore deals with the interrupted request of the second voice channel.

Consequently, the conventional output of the synthesized voices must generate a lot of jitters in the synthesized voice since the first voice channel and the second voice channel are mutually impeded by the overloading of the processing unit 200. In contrast, the latch unit 204 is completely independent of the processing unit 200 and a plurality of timers is incorporated into the latch unit 204 to serve as a trigger mechanism. The latch unit 204 voluntarily fetches the decoded voices in the register 202 according to the first sampling period and the second sampling period. Further, the latch unit 204 regularly sends the decoded voices on each voice channel of the voice synthesizer to solve the problem of the transmission delay due to jitters. More importantly, the acquisition sequence of the decoded voices between the voice channels is on the basis of the sampling period of the timer 206 to avoid interference between decoded voices of the voice channels.

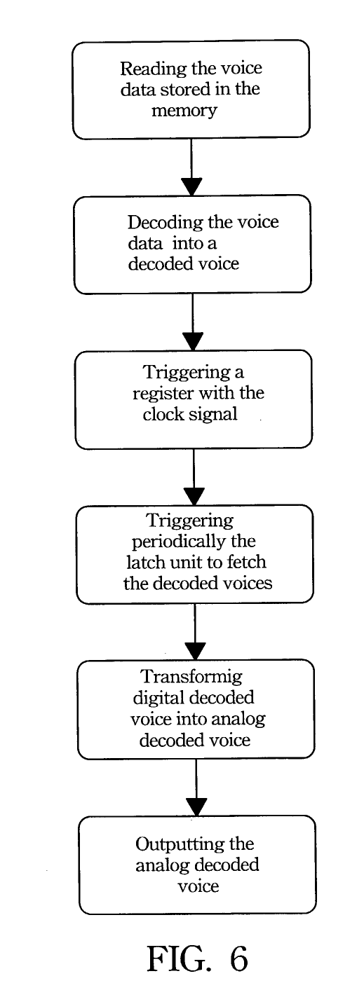

FIG. 6 is a flowchart of operating the voice synthesizer in accordance with one preferred embodiment of the present invention. In step 600, the processing unit reads the voice data stored in the memory according a clock signal. In step 602, the processing unit 200 then decodes the voice data to into a decoded voice. In step 604, the clock signal also is used to trigger a register for receiving the decoded voice from the processing unit to the register.

In next step 606, a plurality of timers form a plurality of sampling signals to control the latch unit. The sampling period responsive to the sampling the signal is used to trigger regularly the latch unit. The latch unit thus actively fetches the decoded voices from the processing unit. Each of the sampling signals is defined as one channel of the synthesized voices. The latch unit transmits the decoded voice of each voice channel on time. Afterwards, the digital/analog converter transforms the digital decoded voice into the analog decoded voice. Finally, the analog decoded voice is output to a speaker.

According to the above, a system and method of synthesizing voices of the present invention utilize a timer to control a latch unit so that the latch unit can fetch decoded voices stored in the register to solve the problem of insufficient MIPS time of the processing unit and to increase the multi-task efficiency of the process of the processing unit. Further, by using a plurality of timers to from a plurality of asynchronous sampling signals allows to trigger the latch unit so that the decoded voices are delivered sequentially according to the period of the sampling signals from the timers for jitter prevention. Additionally, the asynchronous sampling signals of the timers corresponding to various voice channels can diminish the use of the memory of the decoded voices to reduce production cost of the voice synthesizer.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A system of synthesizing a plurality of voices by calculating voice data to generate a synthesized voice to prevent jitters in the synthesized voice, the system comprising:
a memory for storing the voice data;
a processing unit coupled to the memory and triggered by a clock signal so that the processing unit can read the voice data stored in the memory and decode the voice data into a decoded voice;
a register coupled to the processing unit and actuated by the clock signal for receiving the decoded voice from the processing unit;
a latch unit coupled to the register and controlled by a timer for acquiring the decoded voices within the register, wherein the timer transmits a sampling signal to the latch unit for triggering periodically the latch unit according to a period of the sampling signal and the latch unit sequentially reads the decoded voices from the processing unit to prevent jitters in the synthesized voice; and
a digital/analog converter coupled to the latch unit for transferring the decoded voice into an analog synthesized voice to output the analog synthesized voice.

2. The system of claim 1, wherein the latch comprises a plurality of layers of depth for storing the decoded voice from the processing unit.

3. The system of claim 2, wherein the latch comprises a random access memory (RAM).

4. The system of claim 2, wherein the layers of depth comprise a FIFO method of transferring the decoded voice from the processing unit to the latch unit.

5. The system of claim 1, wherein the processing unit comprises a micro-controller or a central processing unit (CPU).

6. The system of claim 1, wherein the processing unit comprises a waveform coding method for coding the voice data in the memory.

7. The system of claim 6, wherein the waveform coding method comprises code excited linear prediction (CELP).

8. The system of claim 6, wherein the waveform coding method comprises adaptive differential pulse code modulation (ADPCM).

9. The system of claim 6, wherein the waveform coding method comprises differential pulse code modulation (DPCM).

10. A system of synthesizing a plurality of voices by calculating voice data in memory to generate a synthesized voice to prevent jitters in the synthesized voice, the system comprising:
a processing unit coupled to the memory and triggered by a clock signal, wherein the processing unit reads the voice data stored in the memory and decode the voice data into a decoded voice;
a register coupled to the processing unit and actuated by the clock signal for receiving the decoded voice from the processing unit;
a latch unit coupled to the register and controlled by a plurality of timers for acquiring the decoded voices within the register, wherein the timers transmit a plurality of sampling signals responsive to the timers to the latch unit for triggering periodically the latch unit according to the different period of each of the sampling signals and the latch unit sequentially reads the decoded voices from the processing unit to prevent jitters in the synthesized voice; and
a digital/analog converter coupled to the latch unit for transferring the decoded voice into an analog synthesized voice and to output the analog synthesized voice.

11. The system of claim 10, wherein the latch comprises a plurality of layers of depth for storing the decoded voice from the processing unit.

12. The system of claim 11, wherein the layers of depth comprises a FIFO method of transferring the decoded voice from the processing unit to the latch unit.

13. The system of claim 10, wherein the processing unit comprises a micro-controller or a central processing unit (CPU).

14. The system of claim 10, wherein the processing unit comprises a waveform coding method for coding the voice data in the memory.

15. The system of claim 14, wherein the waveform coding method comprises code excited linear prediction (CELP).

16. The system of claim 14, wherein the waveform coding method comprises adaptive differential pulse code modulation (ADPCM).

17. The system of claim 14, wherein the waveform coding method comprises differential pulse code modulation (DPCM).

18. A method of synthesizing a plurality of voices by calculating voice data in memory to generate a synthesized voice to prevent jitters in the synthesized voice, the method comprising the steps of:
reading the voice data stored in the memory by using a processing unit according to a clock signal;
decoding the voice data to into a decoded voice by the processing unit;
triggering a register with the clock signal to receive the decoded voice from the processing unit;
controlling a latch unit by generating a plurality of sampling signals responsive to a plurality of timers, wherein the timers transmit a plurality of sampling signals responsive to the timers to the latch unit for triggering periodically the latch unit according the different periods of each of the sampling signals and the latch unit sequentially reads the decoded voices from the processing unit to prevent jitters in the synthesized voice;
transforming the digital decoded voice into an analog decoded voice; and
outputting the analog decoded voice.

19. The system of claim 18, wherein the register comprises a plurality of layers of depth for storing the decoded voice from the processing unit.

20. The system of claim 19, wherein the layers of depth comprise a FIFO method of transferring the decoded voice from the processing unit to the latch unit.

21. The system of claim 18, wherein the processing unit comprises a micro-controller or a central processing unit (CPU).

22. The system of claim 18, wherein the processing unit comprises a waveform coding method for coding the voice data in the memory.

23. The system of claim 22 wherein the waveform coding method comprises code excited linear prediction (CELP).

24. The system of claim 22, wherein the waveform coding method comprises adaptive differential pulse code modulation (ADPCM).

25. The system of claim 22, wherein the waveform coding method comprises differential pulse code modulation (DPCM).
